(19) United States
(12) Patent Application Publication
(10) Pub. No.: US 2024/0025570 A1
(43) Pub. Date: Jan. 25, 2024

(54) Orbit Insertion Device

(71) Applicant: Jacob Eichbaum, Herzliya (IL)

(72) Inventor: Jacob Eichbaum, Herzliya (IL)

(21) Appl. No.: 18/023,358

(22) PCT Filed: Aug. 25, 2021
(86) PCT No.: PCT/IL2021/051040

§ 371 Date: Feb. 25, 2023

Related U.S. Application Data
(60) Provisional application No. 63/069,743, filed on Aug. 25, 2020.

(51) Int. Cl. B64G 5/00

(52) U.S. Cl. CPC B64G 5/00

(57) ABSTRACT

The invention is an implementation of the space elevator wherein an inflatable tube is held up by the force of wind rushing through it from surface to height, in the manner of the ‘inflatable dancer’ used for advertisments. Since the device is neither in tension nor compression, the materials requirements are relaxed. The force of the internal air steam against the interior wall of the tube keeps it from falling, and thus the extreme and practically unattainable requirements of other designs are avoided.

### FIELD OF THE INVENTION

The present invention relates generally to the field of spacecraft launch, in particular the problem of cost per kilogram of mass delivered to orbital heights.

### BACKGROUND OF THE INVENTION

Generally, to get mass into orbit a large, expensive spacecraft is employed, at costs of at least $10,000 USD per kilogram of mass delivered into orbit.

An alternative called the space elevator was proposed at the end of the 19^{th} century. This concept uses a cable or tether anchored to the surface of the earth and extending into space. This permits payloads to attain orbit without the use of large rockets. The competing forces of gravity, which is stronger at the lower end, and the outward/upward centrifugal force, which is stronger at the upper end, would result in the cable being held up, under tension, and stationary over a single position on Earth. With the tether deployed, climbers could repeatedly climb the tether to space by mechanical means, releasing their cargo to orbit. Climbers could also descend the tether to return cargo to the surface from orbit.

Early designs used tall structures in compression, which are conceptually identical to extremely tall buildings. In contrast modern designs for space elevators have focused on purely tensile structures, with the weight of the system held up from above by centrifugal forces. In the tensile concepts, a space tether reaches from a large mass (the counterweight) beyond geostationary orbit to the ground. This structure is held in tension between Earth and the counterweight like an upside-down plumb bob. In both cases (compression and tension) extreme materials requirements have relegated the space elevator to the realm of intriguing fantasy; no known materials can hold their own weight at the required height, for either case.

### SUMMARY OF THE INVENTION

The invention is an implementation of the space elevator wherein an inflatable tube is held up by the force of wind rushing through it from surface to height, in the manner of the ‘inflatable dancer’ used for advertisments. Since the device is neither in tension nor compression, the materials requirements are relaxed. The force of the internal air stream against the interior wall of the tube keeps it from falling, and thus the extreme and practically unattainable requirements of other designs are avoided.

Other embodiments of the invention employ a variation of the principle of ‘David's Sling’ whereby a rotating body may accumulate rotational velocity over a long time period, eventually achieving sufficient velocity to significantly offset the requirements for orbital insertion. In this variation bodies along and at the radial end of a cable are provided with an aerodynamic profile adapted to produce lift, such that as the body rotates around a central axis the radial end is lifted. As the cable and body rotate about the central axis, the cable is paid out thereby reducing centrifugal acceleration to an arbitrary degree. Meanwhile the lifting body will rise higher and higher as its tangential velocity increases. In this manner the lifting body may be raised to an arbitrary height despite the axis being located on the ground.

The foregoing embodiments of the invention have been described and illustrated in conjunction with systems and methods thereof, which are meant to be merely illustrative, and not limiting. Furthermore just as every particular reference may embody particular methods/systems, yet not require such, ultimately such teaching is meant for all expressions notwithstanding the use of particular embodiments.

### BRIEF DESCRIPTION OF THE DRAWINGS

Embodiments and features of the present invention are described herein in conjunction with the following drawings:

### DETAILED DESCRIPTION OF PREFERRED EMBODIMENTS

The present invention will be understood from the following detailed description of preferred embodiments, which are meant to be descriptive and not limiting. For the sake of brevity, some well-known features, methods, systems, procedures, components, circuits, and so on, are not described in detail.

The invention consists of a system and method for sending objects into orbit by means of a ‘space elevator’ or tower upon which objects may be lifted into orbit. The elevator in this case consists of an inflatable tube. To lift objects, they may for instance crawl up the outer surface of the tube. Since the propulsion in this case is simple mechanical travel and not a chemical rocket, the speeds may be minimal and the wasted energy minimal as well; in the case of a chemical rocket a large proportion of the mass to be lifted is simply fuel, while in the case of a crawler nearly all the mass may be payload.

One common application is to put objects into low-earth orbit LEO , for instance at a height of 100 km. In the following we examine some aspects of the invention.

### Bernoulli and Fluid Dynamics

As the velocity of a fluid increases, its pressure decreases, all other things being equal. As the height increases the sum of pressure and a function of velocity decrease, all this being summed up in the Bernoulli equation.

$$\frac{{P}_{1}}{{ρ}_{1}} + \frac{{V}_{1}^{2}}{2} = \frac{{P}_{2}}{{ρ}_{2}} + \frac{{V}_{2}^{2}}{2} + ℊ h$$

Conservation of mass at steady state means that

ρ₁V₁A₁=ρ₂V₂A₂

for any two points along the length of the tube.

For h=100 km and assuming A1=A2:

$$\frac{{V}_{1}^{2} - {V}_{2}^{2}}{2} + \frac{{P}_{1}}{{ρ}_{1}} - \frac{{P}_{2}}{{ρ}_{2}} = \frac{1 {0}^{6} {m}^{2}}{{s}^{2}}$$

and using conservation of mass ρ₁V₁=ρ₂V₂and assuming zero pressure at the outlet, P2=0

$$\frac{{V}_{1}^{2} - {V}_{2}^{2}}{2} + \frac{{P}_{1}}{{ρ}_{1}} = \frac{1 {0}^{6} {m}^{2}}{{s}^{2}}$$

A relation between density and pressure is given through the ideal gas law

P=ρRT

which gives

$$\frac{{V}_{1}^{2} - {V}_{2}^{2}}{2} + RT = \frac{1 {0}^{6} {m}^{2}}{{s}^{2}}$$

If we further assume there is negligible velocity at the outlet, we have

$$\frac{{V}_{1}^{2}}{2} + RT = \frac{1 {0}^{6} {m}^{2}}{{s}^{2}} or {V}_{1}^{2} = \frac{2 * 1 {0}^{6} {m}^{2}}{{s}^{2}} - 2 \frac{{P}_{atm}}{{ρ}_{1}} = \frac{2 * 1 {0}^{6} {m}^{2}}{{s}^{2}} - \frac{2 * 1 {0}^{5} k ℊ m}{{s}^{2} {m}^{2}} \frac{{m}^{3}}{k ℊ} = \frac{2 * 1 {0}^{6} {m}^{2}}{{s}^{2}} - \frac{2 * 1 {0}^{5} {m}^{2}}{{s}^{2}} = 1.8 * 1 {0}^{6} \frac{{m}^{2}}{{s}^{2}} and V = 1340 m / s .$$

The definition of force is:

Fₜₒₜₐₗ/vₘₒₗ=ρa=F_{g}/vₘₒₗ+dP/dh=dP/dh−ρg

where v_mol is the average volume per molecule. from which the barometric formula for density of the earth's atmosphere is derived, by setting F_total=0.

Either the velocity must change, or the factor P/rho must change with height, or some combination. Lets take the first two cases:

$$\frac{{V}_{1}^{2} - {V}_{2}^{2}}{2} = \frac{1 {0}^{6} {m}^{2}}{{s}^{2}} and \frac{{P}_{atm}}{{ρ}_{1}} - \frac{{P}_{2}}{{ρ}_{2}} = \frac{1 {0}^{6} {m}^{2}}{{s}^{2}}$$

In the first case, where velocity is changing, the skin friction on which the system relies will change with height.

The velocity difference is:

$${V}_{1}^{2} - {V}_{2}^{2} = \frac{2 * 1 {0}^{6} {m}^{2}}{{s}^{2}}$$

If the outlet (top) velocity is negligible then the inlet (bottom) velocity is ˜1400 m/s or mach 4. The top velocity is not negligible, and this may be used to impart orbital speed to the cargo. At these heights there is little to no air friction, only mechanical friction, so the orbital velocity that can be imparted is considerable.

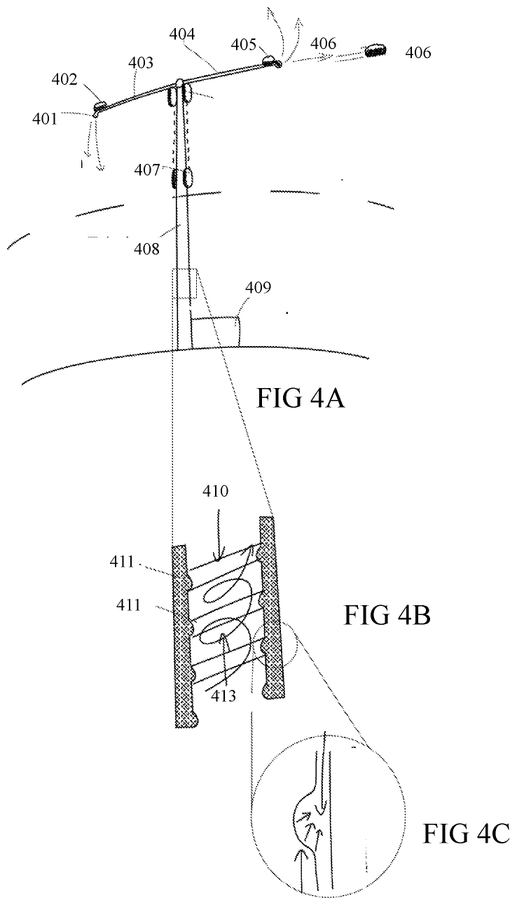

An example of one embodiment for imparting angular or rotational motion to object is shown in FIG. 4. Here a pair of arms at the top of the tower is caused to rotate , for example by use of the mass flow of air up through the tower as a motive force. Once these arms are rotating, a climber may benefit from increasing angular momentum as it moves or is forced out along the arm, for instance by centrifugal force.

To continue with examination of the tower itself:

The shear from skin friction is

$$τ = \frac{F}{A} = C \frac{{V}^{2}}{2}$$

while shear stemming from viscosity is

$$τ = μ \frac{dV}{dx} ,$$

where mu is viscosity and dV/dx is the change in velocity with distance towards the center of the tube.

If the diameter of the tube is d, the tube material density is rho (e.g. 1.5 g/cm³ for plastic) and wall thickness is t (for example 5 mm) then the mass relates to area as m=A*t*ρ and thus the force required is

$$\frac{F}{A} = \frac{m}{A} a = t ρ a = C \frac{{V}^{2}}{2} = 0.005 m * 1500 k ℊ / {m}^{3} * 10 m / {s}^{2} = 750 k ℊ / m * s ∧ 2$$

If we take a skin friction coefficient C then this fixes the velocity, eg for C=0.005

V²=2/0.005*0.005m*1500kg/m³*10m/s²=30000→V=173m/s

This doesnt fit the initial ground velocity but a. we could vary the surface roughness and b. we could change the pipe diameter, large at ground and small at 100 km.

In the following table we show a set of required flow velocities for different surface roughnesses, to attain a constant force per area on the tube surface such that it is held in place.

| Height[m] | Velocity[m/s] | C[ ] | F/A [kg/m * s2] |
|---|---|---|---|
| 0 | 1400 | 0.0007653061 | 750 |
| 1000 | 1392.9824119 | 0.0007730365 | 750 |
| 10000 | 1328.1566173 | 0.0008503401 | 750 |
| 50000 | 989.94949366 | 0.0015306122 | 750 |
| 99000 | 140 | 0.0765306122 | 750 |

This requires an unreasonably low friction factor at the bottom of the tube and therefore the velocity would have to be decreased, for instance by increasing the diameter at the bottom.

### Side Force

Assuming the problem above can be addressed there is another practical problem namely the ‘side force’ from winds on the tube. One standard used in wind engineering is the Hellman formula (a polynomial)

V(h)=V₁₀(h/h₁₀)^{α}

The total force on a column of height H will then be

F=ρA*C_{d}*V²

Using the drag coefficicent perpendicular to a cylinder of 0.3 we get , using A=d*dh for a cylinder of diameter d and height element dh:

Fₜₒₜ=∫₁₀¹⁰⁰⁰⁰⁰ρd*C_{d}*V²dH

the air here is the external air which varies with height according to ρ=ρ₀exp(−h/H) with H=10.4 km. Solving this we get

$${F}_{tot} = {rho}_{0} {C}_{d} d \frac{{V}_{10}}{{h}_{10}^{α}} {\int }_{10}^{100000} exp ( - h / H ) {h}^{α} dh = 1 * 0.3 * 1 * 1 / ( {10}^{0.1} ) * 25 \; 000 = 9400 k ℊ m / {s}^{2}$$

Note however that the wind speed formula is probably valid only for relatively low heights, and jetstreams at ˜10 km may have to be taken into account.

In any case the side force of at least 10 tons would have to be resisted by the device.

To deal with this side force, there are several possible approaches.

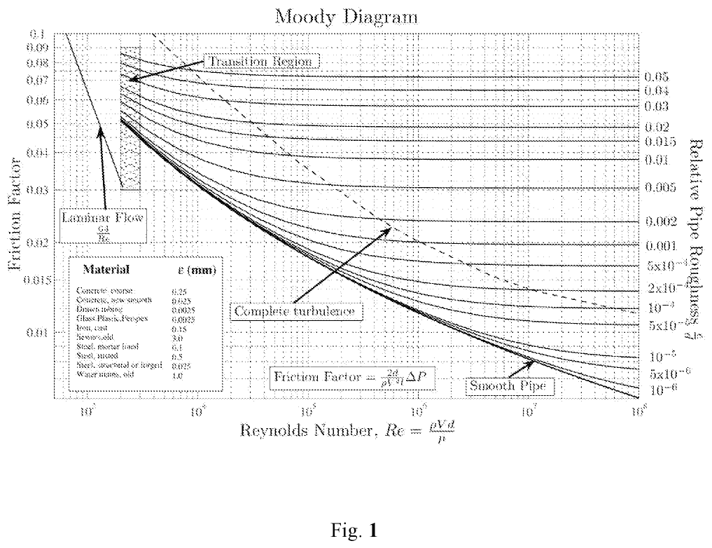

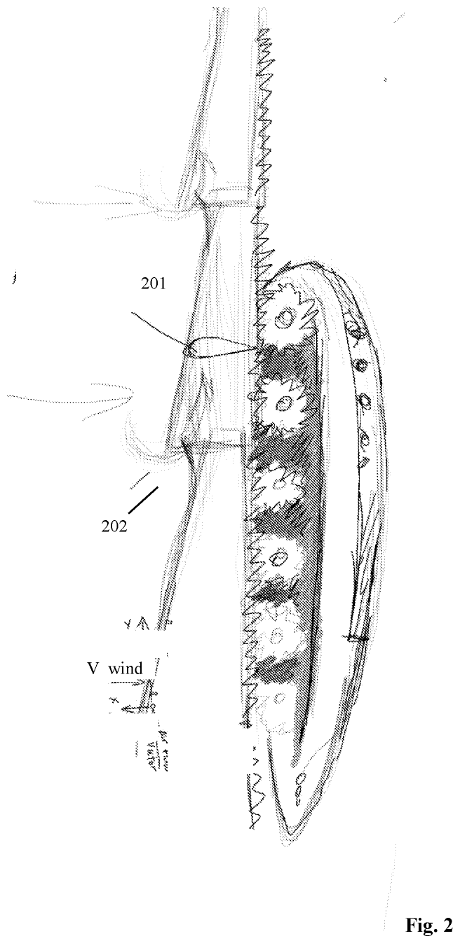

One possibility is to use a noncircular profile for the tube, as shown in FIG. 2. The profile may be chosen such that the wind force against the tube is countered by a force from the air flow within the tube, due to the profile chosen. Alternatively the profile may be shaped such that a horizontal force is produced, again in the direction opposite the expected direction of external prevailing winds. Another possibility is to introduce holes into the tube (e.g. on the side opposite the expected wind) that will also tend to produce a counter force in the direction opposite to the force expected from the wind.

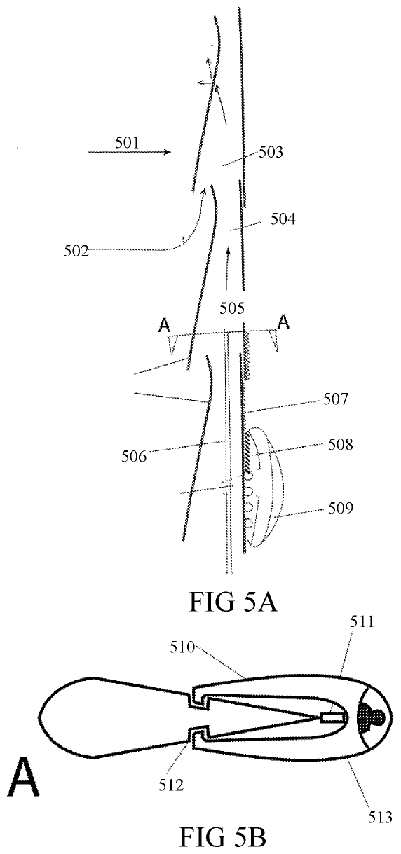

An illustration of one possible solution to the problem of side force is shown in FIG. 5. Here one sees downward-facing openings in the tube, which allow external air to be pulled into the main tube due to the low pressure inside the tube. This air enters from one side only and will therefore exert a sideways force on the tube; if the vents are located on the same side of the tube as the prevailing winds, the tendency will be to offset the force of the wind to some degree.

### Power

The initial velocity, which will apparently be somewhere 170 m/s and 1400 m/s, has to be supplied by forcing air into the tube, which will require a minimum of energy proportional to the mass flow. The diameter of the tube and initial density will determine the mass flow,

m/t=ρV A

The power required to get this mass to speed is

P=½m/tV²=½ρV³A

If for instance we take the lower figure of 140 m/s for velocity, a tube diameter of 10 m, and atmospheric air density of 1 kg/m∧3, this comes to 100 MW.

The power to get a kilogram into orbit will depend on how fast it needs to get there. An energy of mgh is required to get the mass to height h, so for 1kg at 100 km this is 10∧6 J. If a day's journey is ok then this only takes 11 W, negligible compared to the power required to keep the tube inflated.

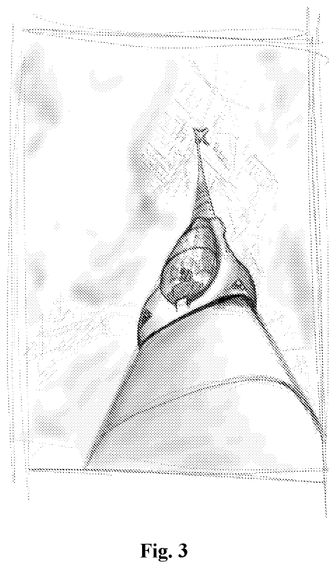

FIG. 3 shows one possible embodiment of the invention, with a tapered diameter such that the tube diameter decreases with height, and shows a cart going up the tube (perspective laws make it look smaller at ground level).

To achieve a significant insertion velocity, cables may be paid out from the central tower of the device as shown in FIGS. 4A, B, C. In this embodiment the crawlers 407 crawl up the central tower as before, which also as before is held up by the shear flow of air up the tube and out the top of the tower. The crawlers are then spun around centrifugally, such that they are launched radially outwards with significant velocity as in the launched crawler 406.

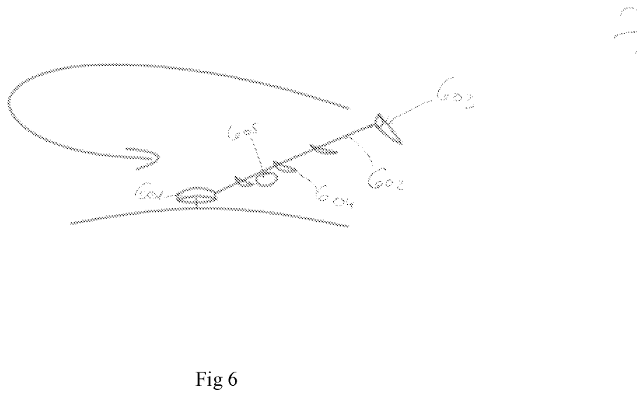

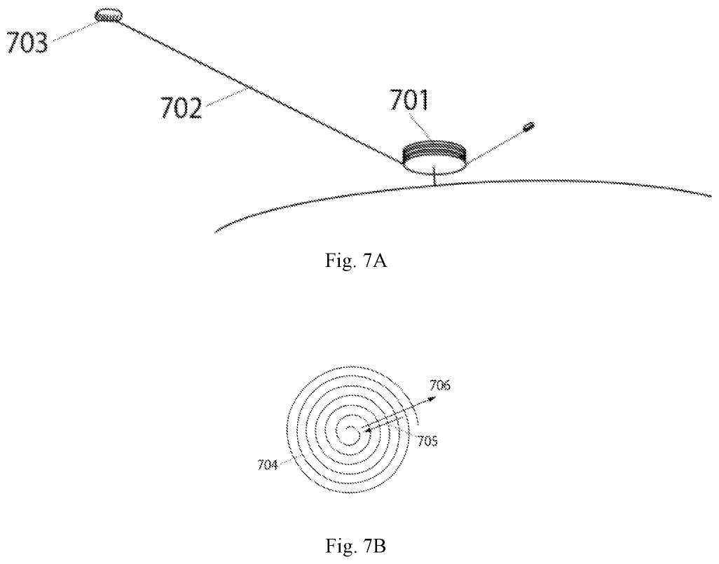

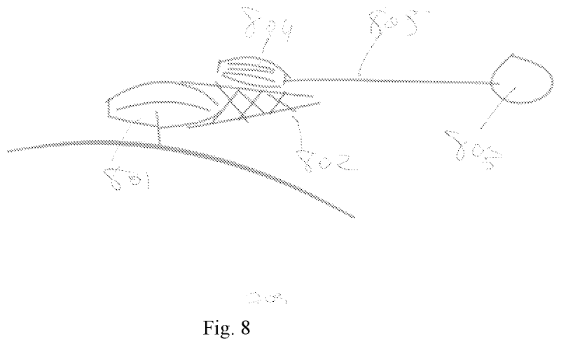

Other embodiments of the invention employ a variation of the principle of ‘David's Sling’ whereby a rotating body may accumulate rotational velocity over a long time period, eventually achieving sufficient velocity to significantly offset the requirements for orbital insertion. In this variation a body at the radial end of a cable is provided with an aerodynamic profile adapted to produce lift, such that as the body rotates around a central axis the radial end is lifted. As the cable and body rotate about the central axis, the cable is paid out thereby reducing centrifugal acceleration to an arbitrary degree. Meanwhile the lifting body will rise higher and higher as its tangential velocity increases. In this manner the lifting body may be raised to an arbitrary height despite the axis being located on the ground. Such an embodiment is shown in FIGS. 6, 7 wherein a central rotating element 601 provides rotational energy to the system. Cables 602 are payed out from the central rotating element, eventually achieving significant lengths. A lift-producing body is attached to the ends of the cables, and in this manner the distal ends of the cables may be lifted arbitrarily high, limited only by the rotational speed of the system, and the lift-to-weight ratio of the lift producing bodies. As will be appreciated by one skilled in the art, the centrifugal force upon the cable (and any elements attached to it such as the lift-producing body or crawlers 605) can be reduced by increasing the speed at which the cable is payed out.

In FIG. 7A the basic shape of central rotating element and lift-producing body is shown. In FIG. 7B spiral shape of the path of the end of the cable is shown, while FIG. 7C shows one example of a lift-producing profile for the lift-producing body.

The foregoing description and illustrations of the embodiments of the invention has been presented for the purposes of illustration. It is not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

1. A device adapted to lift objects to a given height, consisting of a flexible, inflated tube containing a volume of pressurized air forced into the base of said tube at ground level, and out the top of said tube, wherein the tube is not held in place by tension or compression but rather by the shearing force of the air flow therethrough, and wherein climbing devices may climb the surface of said tube.

2. The device of claim 1 wherein said climbing devices surround the outer circumference of said tube, taking the form of a ring.

3. The device of claim 1 wherein the top of said tube is at a height of at least tens of kilometers above the surface of the earth.

4. The device of claim 1 having a noncircular cross section such that the external wind force against the tube is countered by the force from the air flow within the tube .

5. The device of claim 1 provided with holes on the side opposite the expected external wind, adapted to produce a counter force in the direction opposite to the force expected from the wind.

6. The device of claim 1 wherein the tube is produced from ultra high molecular weight polyethylene (UHMWPE) or other polymer.

7. The device of claim 1 wherein said tube is a double-walled tube, and wherein said pressurized air is directed into the annulus formed by said double-walled tube.

8. The device of claim 1 wherein temperature and pressure gradients are exploited to force air into the base of said tube.

9. The device of claim 1 wherein one or more fans are used to force air into the base of said tube.

10. A method for lifting objects to a given height consisting of the steps:
a. conducting pressurized air into the base of a flexible, hollow tube having one end anchored on the ground and the other end free, said pressurized air flowing up the inside of said tube and out the top of said tube;
b. sending climbing devices adapted to climb up the surface of said tube;
whereby the materials constraints of a rigid tower are avoided.

11. The method of claim 10 wherein said climbing devices surround the outer circumference of said tube, taking the form of a ring.

12. The method of claim 10 wherein the top of said tube is at a height of at least tens of kilometers above the surface of the earth.

13. The method of claim 10 having a noncircular cross section such that the external wind force against the tube is countered by the force from the air flow within the tube .

14. The method of claim 10 provided with holes on the side opposite the expected external wind, adapted to produce a counter force in the direction opposite to the force expected from the wind.

15. The method of claim 10 wherein the tube is produced from ultra high molecular weight polyethylene (UHMWPE) or other polymer.

16. The method of claim 10 wherein said tube is a double-walled tube, and wherein said pressurized air is directed into the annulus formed by said double-walled tube.

17. The method of claim 10 wherein temperature and pressure gradients are exploited to force air into the base of said tube.

18. The method of claim 10 wherein one or more fans are used to force air into the base of said tube.

19. The method of claim 10 further providing a pair of cables running from ground level to the top of said tube, and radially out the top of said tube, and further wherein said tube and said cables are caused to rotate around the long axis of said tube, said cables being paid out gradually so as to control the centrifugal force upon them.

20. A device for lifting objects to a given height comprising:
a. a central rotating axis;
b. two or more cables attached to said rotating axis, said cables adapted to being payed out as said axis rotates;
c. aerodynamic lifter elements at the distal ends of said cables adapted to produce upward lift tending to raise the distal ends of said cables ;
whereby the centrifugal force upon said cables and lifter elements is countered to some degree by means of paying out said cable.

21. The device of claim 20 wherein a device to be launched is attached to one of said cables near said axis, and wherein said device is payed out upon said cable towards the distal end of said cable, thereby decreasing centrifugal force upon said cable.

22. A method for lifting objects to a given height comprising:
a. providing a central rotating axis 601;
b. attaching said two or more cables 602 to said rotating axis;
c. attaching aerodynamic lifter elements 603 to the distal ends of said cables, said lifter elements being adapted to produce upward lift that raises the distal ends of said cables ;
d. paying out said cables as said axis rotates;
whereby the centrifugal force upon said cables and lifter elements is countered to some degree by means of paying out said cable.

23. The method of claim 22 wherein a device to be launched 605 is attached to one of said cables near said axis, and wherein said device is payed out upon said cable towards the distal end of said cable, thereby decreasing centrifugal force upon said cable.

24. The method of claim 22, wherein air-foil surfaces 604 along said cable use the atmospheric air to generate drag force that would counter the tension created by centrifugal force along the spinning cable.

25. The method of claim 22 wherein said cable gains angular speed by an azimuthal thrust generating device at the distal end of said cable.

26. The method of claim 22 further providing a tethered spinning cart 703 that is let-out from the ground level spinning device that houses a rolled cable 701 at a growing rate, such that cart is let out radially while spinning (creating a spiral path 704), and whereby the centripetal acceleration and tension in said cable is reduced.

27. The device of claim 22 wherein a rolled cable 803 is spun from ground level device 801 to gain potential kinetic energy and released when reaching a predetermined target speed, while connected to a cargo-cart 804, said rolled cable 803 being payed out from said cargo-cart at a predetermined rate, while a braking system gradually reduces the pay-out speed such that the cart attains a target speed.
